(19) United States
(12) Patent Application Publication
(10) Pub. No.: US 2019/0230091 A1
(43) Pub. Date: Jul. 25, 2019

(54) Method for Implementing Intelligent Parental Controls

(71) Applicants: Todd Jeremy Marlin, Pleasantville, NY (US); Marisa Marlin, Pleasantville, NY (US)

(72) Inventors: Todd Jeremy Marlin, Pleasantville, NY (US); Marisa Marlin, Pleasantville, NY (US)

(21) Appl. No.: 15/969,458

(22) Filed: May 2, 2018

Related U.S. Application Data
(60) Provisional application No. 62/620,257, filed on Jan. 22, 2018.

(51) Int. Cl. H04L 29/06; G06F 21/62

(52) U.S. Cl. CPC H04L 63/102; G06N 99/005; G06F 21/6218

(57) ABSTRACT

A method for implementing intelligent parental controls uses a remote server to manage a child profile that is associated to a child computing device. The child profile is associated to static prohibitions that have been defined by a parent and dynamic prohibitions that are generated by a machine learning engine. The static prohibitions and the dynamic prohibitions are rulesets that define the activities in which child profile is allowed to engage. The child device is continually monitored to identify if the child is interacting with the child device. The behavioral information from the child's interactions is sent to the remote server as a group of behavioral datasets. The method is then used to categorize the behavioral datasets as either statically or dynamically prohibited based on contextual information contained in the datasets. The method then executes a behavioral modification process to generate an appropriate response to the child's actions.

The current application claims a priority to the U.S. Provisional Patent application Ser. No. 62/620,257 filed on Jan. 22, 2018.

### FIELD OF THE INVENTION

The present disclosure generally relates to the field of access control. More specifically, the present disclosure relates to a method and a system for implementing intelligent parental controls.

### BACKGROUND OF THE INVENTION

In the current digital age, children are exposed to a lot of digital content every day. There is a need for parental control on the various devices used by the children. However, the current parental control systems allow for only binary decision making. Accordingly, the parents may only turn features on or off on the various devices used by the children.

However, in real life, parents do not make only binary decisions for children. For example, a parent may be okay with certain types of photos being uploaded to social media and not others. Therefore, the context of the behavior and action is important to know before a parent decides to allow or deny access. Further, the current parental control systems do not evolve with as the child grows.

Yet further, existing systems do not provide the facility to positively train children or employees to use devices in positive ways.

Moreover, the parents are required to separately configure controls on each device used by children. This may involve a lot of effort.

Therefore, there is a need for improved methods and systems for implementing intelligent parental controls, and that may overcome one or more of the above-mentioned problems and/or limitations.

The method of the present invention provides an intelligent parental controls system takes the opposite approach to traditional parental control systems. Traditionally, parental control systems work by denying or allowing specific predefined behaviors or access. Tools exist to monitor the child's behavior. However, none provide the facility to positively train children how to use devices responsibly. The method of the present invention is modeled after traditional parenting, which primarily uses a reward-based system. Using the method of the present invention, the child, or person under supervision must perform designated positive activities, as well as activities that the machine learning engine has designated as positive, to earn various privileges. For example, performing recreational activities or activities that can be abused such as, streaming songs and videos, visiting social media sites, and playing video games. Preferably, the present invention employs a point-based system that is tailored or customized to how the parent wants to reward behavior. Alternatively, multiple children being monitored can compete to determine who can earn the most points. Thus, incentivizing positive behavior.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, an online platform for implementing intelligent parental controls is disclosed. The online platform may be hosted, for example, on a cloud computing service. Alternatively, the online platform may be hosted on any electronic device, such as, for example, a desktop computer, a portable computer, a wearable computer etc. The online platform may provide an application for parents to download and install on the one or more parent devices and one or more children devices. The application may monitor the one or more children devices. Further, the application may allow the online platform to create a log of all parental decisions and sample activity reviewed and associated decisions. The online platform may also create a log of all activities performed on the one or more children devices. The online platform may store the logs in a master database. Further, the online platform may include an Artificial Intelligence (AI) engine that may learn based on data in the master database.

According to some embodiments, an application for implementing intelligent parental controls is disclosed. The application may be installed on the one or more parent devices and the one or more children devices. The term children devices, as used in the present disclosure may in some instances refer to devices operated by individuals (e.g. elderly people, disabled persons etc.) under supervision by parents. After installation on the one or more children devices, the application may be configured to automatically create a unique registry of all potential activity types that may be performed on the one or more children devices. Thereafter, the application may undergo training. The application may include an AI engine which may develop a machine learning model during training. The training may include obtaining libraries that have been pre-configured with pre-trained models for levels of desired capability. Further, the training may include allowing the parents to create customized rules that relate to unique knowledge about the child and where they live. Moreover, during training, the application may monitor the one or more children devices. The application may monitor all interactions between the children and the one or more children devices. The application may report an interaction to the parents. Then, the parents may approve or deny interactions. The machine-learned model may be updated based on the parents' decisions. After training, the application may continuously monitor the one or more children devices. In case, the application discovers a new interaction, the application may send an alert to the one or more parent devices. Further, the application may perform an action based on the response received from the one or more parent devices.

Moreover, the application may be configured to award points to children based on positive activities performed on the corresponding children devices. The parent may designate what types of behaviors and app usage can be earned. This approach models traditional parenting based on a reward system but translates it to the digital world.

In some embodiments, a monitoring system is disclosed. The monitoring system may identify conduct (activities, content, and context) on one or more children devices. Further, the monitoring system may provide a facility for the parent(s) to make decisions on full or samples of this conduct. The decisions may include approve, deny, or hold in a certain context. As a result, both supervised and unsupervised machine-learned models may be generated using an AI engine in the monitoring system.

The disclosed methods, applications, systems operate on digital devices and provide a mechanism for implementing customized parental controls that evolve over time as the child grows and matures into an adult. Alternatively, in cases of other individuals in need of supervision such as the elderly and/or disabled people, such customized parental controls may also evolve with the changing needs of such individuals. The disclosed methods, applications, systems enable a parent to provide parental control associated with electronic devices operated by a child based on a context (e.g. app, action, other users involved, intention etc.) of an activity (e.g. taking pictures, communicating online etc.) performed by the child. Further, disclosed methods, applications, systems use artificial intelligence to automatically learn parental control rules based on the analysis (e.g. image analysis, natural language processing, speech analysis etc.) of contextual data associated with an activity on the electronic device of the child and associated parental action (i.e. approval/denial/hold). Further, the disclosed methods, applications, systems enable customized parental control to automatically evolve over time as the child grows. Yet further, the disclosed methods, applications, systems provide pre-trained models for parental control based on context and associated levels or groups of children. Moreover, the disclosed methods, applications, systems provide a master database of parental control rules received from a plurality of parents and generating parental control suggestions based on the master database and an input criterion (e.g. one or more demographic variables of a child).

In further embodiments, employers may use the disclosed methods, systems, application and platforms in the workplace. The employers may designate what types of behaviors may be rewarded.

In further embodiments, the disclosed methods, systems, application and platforms may be used by caregivers to encourage positive behavior by addicts, recovering alcoholics, and the elderly. The caregivers may designate what types of behaviors may be rewarded.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is a flowchart describing a sub-process for identifying and responding to rewarded behaviors using the method of the present invention.

FIG. 4 is a flowchart describing a sub-process for identifying statically prohibited behaviors using the method of the present invention.

FIG. 5 is a flowchart describing a sub-process for identifying dynamically prohibited behaviors using the method of the present invention.

FIG. 6 is a flowchart describing a sub-process for responding to statically prohibited behaviors using the method of the present invention.

FIG. 7 is a flowchart describing a sub-process for responding to dynamically prohibited behaviors using the method of the present invention.

FIG. 8 is a flowchart describing a sub-process for generating dynamic prohibitions using the method of the present invention.

FIG. 9 is a flowchart describing a sub-routine for enabling the parent account to manage the child profile using the method of the present invention.

FIG. 10 is a flowchart describing a sub-process for generating a new child profile using the method of the present invention.

FIG. 11 is a flowchart describing a sub-process for adding new static prohibitions to the child profile using the method of the present invention.

FIG. 12 is a flowchart describing a sub-process for creating new stored prohibitions using the method of the present invention.

FIG. 13 is a flowchart describing a sub-process for creating new behavioral response procedures using the method of the present invention.

### DETAIL DESCRIPTIONS OF THE INVENTION

All illustrations of the drawings are for the purpose of describing selected versions of the present invention and are not intended to limit the scope of the present invention.

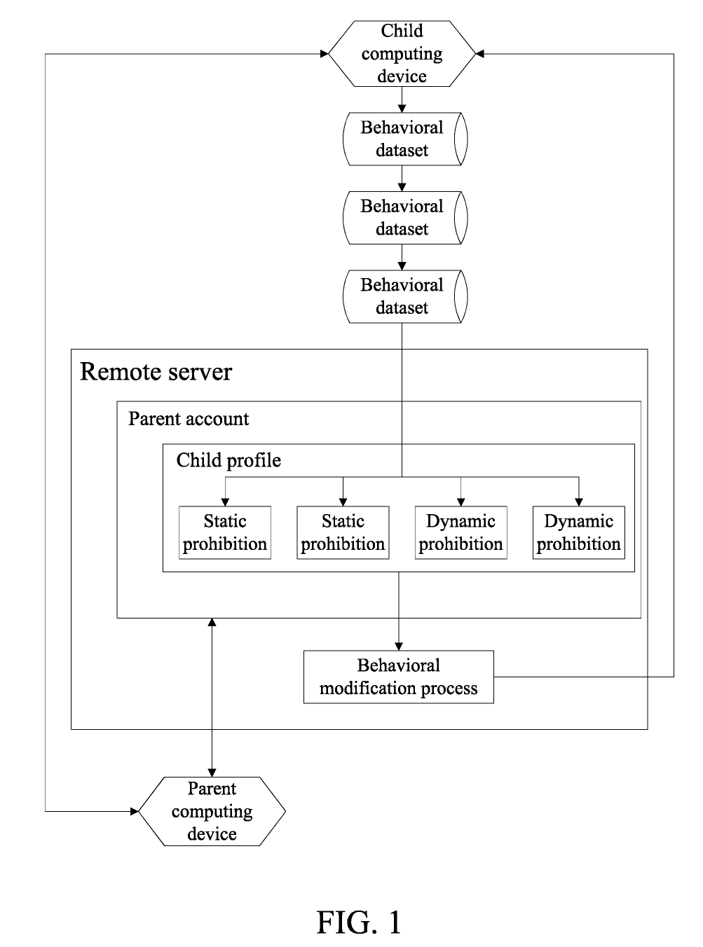

Referring to FIG. 1 through FIG. 13, the present invention, the method for implementing intelligent parental controls, is a method that enables a parent to monitor and modify the behavior of a child while the child is using a child computing device. The term ‘parent’ is used herein at refer to any individual who is charged with monitoring the activities on another and may be taken to describe individuals including, but not limited to, teachers, administrators, caregivers, and managers. The term ‘child’ is used herein to refer to any individual who is subject to behavioral restrictions, such that the individual's activities are monitored. The method of the present invention is designed to monitor the child's activities in order to determine if the child is using the child device to engage in prohibited activities. Additionally, the method of the present invention is designed to determine when the child is using the child device to engage in sanctioned activities. Further, the method of the present invention makes use of a machine learning engine to dynamically classify previously unknown behaviors as prohibited or sanctioned. As a result, the method of the present invention is able to function as an adaptive parental control system that adapts to changes in the child's behavior over time. Further, the method of the present invention is able to reward the child for engaging in sanctioned activities. Thus, inculcating positive values and behavioral norms in the child.

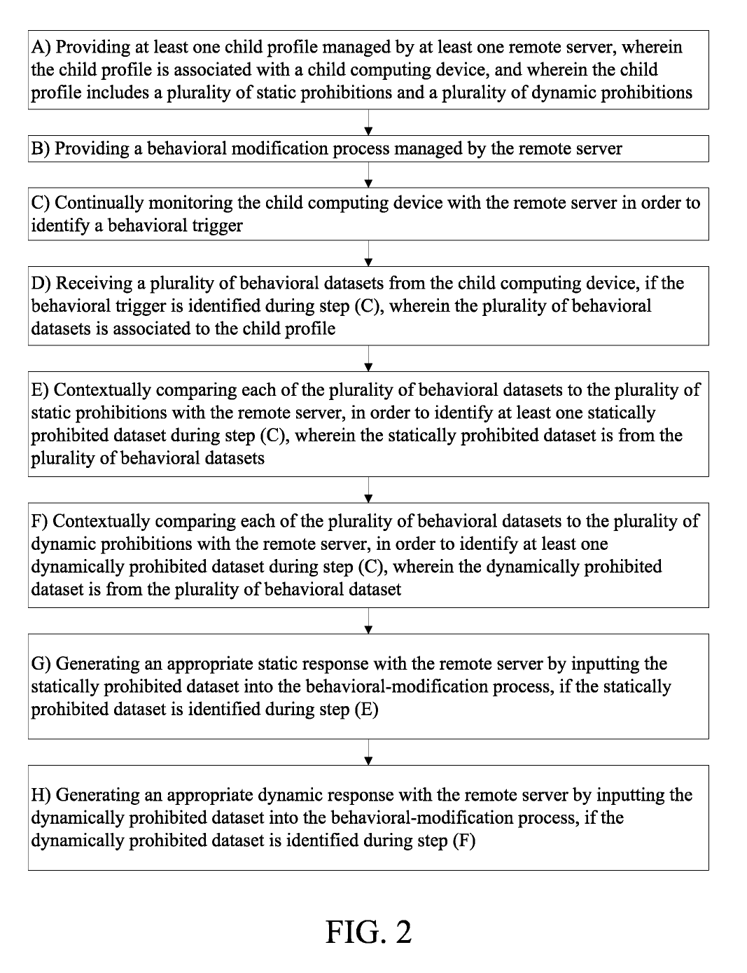

Referring to FIG. 2, the system required to implement the method of the present invention makes use of a remote server to monitor the behaviors of the child while interacting with the child device. Specifically, the system provides at least one child profile managed by at least one remote server (Step A). The remote server is used to facilitate communication between the child profile and an associated parent account. Moreover, the remote server is used to execute a number of internal processes for the present invention and is used to store system data. The child profile is a record that contains information that is unique to the child being monitored. While the following descriptions cover the method of the present invention being applied to a single child profile, the behaviors of multiple children can be simultaneously tracked and modified using the method of the present invention. The child profile is associated to a child computing device so that the child's interactions with the child computing device are correlated to the child profile. The term ‘computing device’ is used herein to refer to an electronic system that is capable of communicating with the remote server, executing the method of the present invention, and interacting with a user. Accordingly, the method of the present invention is able to monitor the child's behavior while using the child computing device.

The child profile includes a plurality of static prohibitions and a plurality of dynamic prohibitions. The plurality of static prohibitions is a dataset that contains descriptors which identify behaviors that the parent has characterized as being prohibited. For example, the parent may characterize visiting a specific website as prohibited. Thus, the parent-provided characterization of the website is classified as a single static prohibition. Accordingly, whenever the child attempts to visit the website using the child computing device, the method of the present will determine that the child is engaging in a prohibited behavior. Alternatively, the plurality of static prohibitions may contain descriptors which identify behaviors that have been characterized as being prohibited by behavioral models received from an external source. Further, the externally-sourced behavioral models may be generated using data that includes, but is not limited to, regional behavioral patterns, age, gender, and economic stratification. Similar to the plurality of static prohibitions, the plurality of dynamic prohibitions is a dataset that contains descriptors which identify behaviors. However, rather than being characterized by the parent, the machine learning engine generates behavioral characterizations in real time. This enables the method of the present invention to identify and respond to the child engaging in previously unknown behaviors. To that end, the system required to execute the method of the present invention provides a behavioral modification process managed by the remote server (Step B).

The behavioral modification process is a routine that is used to determine the appropriate response to an identified behavior. That is, the behavior modification process analyzes the activities that the child is engaging in and assesses how the method of the present invention will react in light of any pertinent contextual information. For example, if the child attempts to access a social media website while at school, the behavioral modification process may determine that the activity should be characterized as prohibited, and then execute an appropriate procedure for how to respond to the child's actions. However, if the child attempts to access a social media website during the weekend, the behavioral modification process may determine that the activity should be allowed, and then a completely different response procedure may be executed. These response procedures may comprise steps that include, but are not limited to, alerting the parent, preventing the child from accessing the website, and displaying a message that provides the child with reasons why the behavior is prohibited. Further, the behavioral modification process uses the machine learning engine to adapt to changes in the child's behavior over time. This is accomplished by forming historically accurate behavioral models for the child's activities. Additionally, the machine learning engine may utilize externally-sourced behavioral models for training and real-time classification of the behavioral datasets.

Referring to FIG. 2, the overall method of the present invention runs as a background process that monitors the child's activities and is able to function as a real-time system for implementing parental controls. To achieve this, the overall method of the present invention begins by continually monitoring the child computing device with the remote server in order to identify a behavioral trigger (Step C). The behavioral trigger is an event that occurs through the child's interaction with the child computing device. For example, the behavioral trigger may be actions which the child performs with the child computing device. These actions include, but are not limited to, opening a certain program, receiving a message, browsing web pages, and waking the child computing device from sleep.

The remote server continually monitors the child computing device in the background to determine if the behavioral trigger has occurred so that the method of the present invention can begin analyzing the child's activity. The overall method of the present invention continues by receiving a plurality of behavioral datasets from the child computing device if the behavioral trigger is identified during Step C (Step D). The plurality of behavioral datasets includes information that describes the activities which the child uses the child computing device to perform. Additionally, each of the behavioral datasets includes contextual information that further characterizes the child's activity. For example, opening and responding to a message with the child computing device may be characterized by a behavioral dataset. Likewise, opening a web browser and navigating to a webpage may be characterized by a separate behavioral dataset. Further, each of these behavioral datasets will be associated to the child profile so that a longitudinal analysis can be performed to identify changes in the child's behavior, as well as negative and positive behavioral trends.

Referring to FIG. 2, once the remote server begins receiving the behavioral datasets, the present invention begins analyzing the child's behavior to determine if the child is engaging in prohibited activities. To that end, the overall method of the present invention continues by contextually comparing each of the plurality of behavioral datasets to the plurality of static prohibitions with the remote server, in order to identify at least one statically prohibited dataset during Step C (Step E). The statically prohibited dataset is a behavioral dataset that characterizes an activity the child is not authorized to perform. Specifically, the statically prohibited dataset characterizes an activity that the parent has previously defined as prohibited. As a result, the parent is able to hardcode prohibitions for certain activities.

Referring to FIG. 2, in addition to identifying certain predefined behaviors as prohibited, the overall method of the present invention is designed dynamically characterize previously unknown behavioral datasets as prohibited. Specifically, the overall method of the present invention continues by contextually comparing each of the plurality of behavioral datasets to the plurality of dynamic prohibitions with the remote server, in order to identify at least one dynamically prohibited dataset during Step C (Step F). The dynamically prohibited dataset is a behavioral dataset that characterizes an activity the child is not authorized to perform. Further, the method of the present invention employs the machine learning engine to analyze the child's previous behaviors in light of the plurality of static prohibitions in order to determine if a previously unknown behavioral dataset should be characterized as prohibited. For example, if the child is prohibited from accessing specific social media websites, the machine learning engine will determine that social media websites are prohibited. Thus, when the child attempts to access a previously unknown social media website, the overall method of the present invention will identify the behavior as a dynamically prohibited dataset and respond accordingly. As a result, the method of the present invention is able to adapt to changes in the child's behavior over time.

Referring to FIG. 2, after the behaviors are characterized as either statically or dynamically prohibited, the overall method of the present invention executes sub routines to identify and perform appropriate responses. Specifically, the overall method of the present invention continues by generating an appropriate static response with the remote server by inputting the statically prohibited dataset into the behavioral-modification process, if the statically prohibited dataset is identified during Step E (Step G). The appropriate static response is a procedure that is executed to modify the child's behavior when the child is engaging in activities that the parent has characterized as prohibited. That is, the method of the present invention will execute a specific procedure depending on the type of behavior that was identified as statically prohibited during Step E. For example, the appropriate static response when the child attempts to access a prohibited social media website may include notifying the parent and rerouting the child's web browser to a previously defined educational webpage. The overall method of the present invention continues by generating an appropriate dynamic response with the remote server by inputting the dynamically prohibited dataset into the behavioral-modification process, if the dynamically prohibited dataset is identified during Step F (Step H). The appropriate dynamic response is a procedure that is executed to modify the child's behavior when the child is engaging in activities that the machine learning engine has characterized as prohibited. That is, the method of the present invention will execute a specific procedure depending on the type of behavior that was identified as dynamically prohibited during Step F. Similar to the appropriate static response, the appropriate dynamic response, when the child attempts to access a prohibited social media website, may include notifying the parent and rerouting the child's web browser to a previously defined educational webpage.

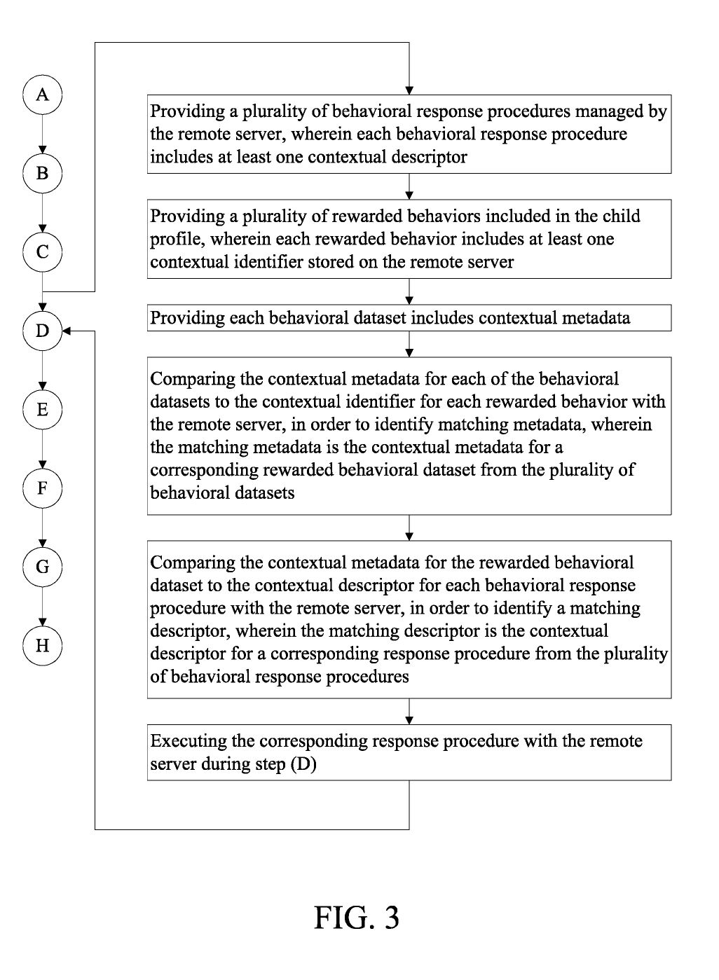

Referring to FIG. 3, as described above, the method of the present invention is designed to modify the child's behavior by rewarding positive behaviors, as well as punishing negative behaviors. To that end, the method of the present invention includes a sub-process for identifying rewarded behaviors and providing an appropriate reward or response. The system required to execute the method of the present invention enables this sub-process by providing a plurality of behavioral response procedures managed by the remote server. The plurality of behavioral response procedures contains a set of routines that will be executed in in response to a behavioral dataset that has been characterized as statically prohibited, dynamically prohibited, or rewarded. Each behavioral response procedure includes at least one contextual descriptor. The contextual descriptor is a piece of contextual data that is used to describe the types of behavioral datasets, as well as the contextual milieu, for which an associated behavioral response procedure would be appropriate. The system required to execute the method of the present invention further provides a plurality of rewarded behaviors included in the child profile. The plurality of rewarded behaviors is a dataset that contains a list of the behaviors which the parent has characterized as worthy of a reward. Further, each rewarded behavior includes at least one contextual identifier that is stored on the remote server. The contextual identifier describes the types of behavioral datasets which fall within a corresponding rewarded behavior. Alternatively, the plurality of rewarded behaviors may contain lists of behaviors that have been characterized as worthy of a reward by behavioral models received from an external source. Each behavioral dataset includes contextual metadata that is used to describe the type of activities that the child engages in while using the child computing device.

Referring to FIG. 3, the aforementioned sub-process enables the parent to reward positive behaviors. This sub-process begins by comparing the contextual metadata for each of the behavioral datasets to the contextual identifier for each rewarded behavior with the remote server, in order to identify matching metadata. In this step, the matching metadata is the contextual metadata for a corresponding rewarded behavioral dataset from the plurality of behavioral datasets. Further, the comparison between the contextual identifier and the contextual metadata is used to identify the behavioral dataset that should be characterized as a rewarded behavior. Thus characterized, the sub-process begins a routine for providing an actual reward that is commensurate with the corresponding rewarded behavior. The sub-process continues by comparing the contextual metadata for the rewarded behavioral dataset to the contextual descriptor for each behavioral response procedure with the remote server, in order to identify a matching descriptor. In this step, the matching descriptor is the contextual descriptor for a corresponding behavioral response procedure from the plurality of behavioral response procedures. Further, the comparison between the contextual metadata and the contextual descriptor is used to identify the behavioral response procedure that provides the actual reward which is commensurate with the corresponding rewarded behavior. Once the corresponding response procedure is identified, the sub-process concludes by executing the corresponding response procedure with the remote server during Step D. Thus, the child is rewarded for performing positive behaviors.

The present invention is designed to be a flexible system that is capable of executing various behavior response procedures when providing rewards to the child. That is, the behavior response procedure may be used to update an ongoing record which correlates specific rewarded behaviors to varying amounts of points. In this way, the child can accrue points in a bank that can be spent on rewards of the child's choosing. Additionally, the points can be spent to reclassify previously prohibited behaviors as sanctioned behaviors. For example, visiting a social media site may be a prohibited behavior for the child, while reading an electronic book is a rewarded behavior. In this example, the behavioral response procedure may be to award the child a point for every five minutes spent reading the electronic book. Additionally, the child may be able to exchange a predefined number of points for a set number of minutes where visiting the social media site is no longer a prohibited behavior. In this way, the method of the present invention is able to inculcate positive values in the child. Similarly, the child may be able to exchange accrued points for various other forms of compensation that include, but are not limited to, physical objects, digital experiences, and monetary rewards. Because the present invention is designed to function as a behavioral modification system, the behavioral response procedure may include steps that provide training modules to the child whenever behaviors are reclassified from prohibited to sanctioned. Another aspect of the points-based rewards system is the establishment of a competitive environment between multiple child profiles that are being monitored using the method of the present invention. The corresponding behavior response procedure may include steps that define the rewards associated with being the first child to reach a predetermined number of points. Additionally, the sub-process may compile the corresponding rewarded behavioral datasets into a database. Thus compiled, the method of the present invention is able to perform longitudinal analysis of the child's behavior and track the effectiveness of various behavioral response procedures in inculcating positive behaviors and attitudes within the child.

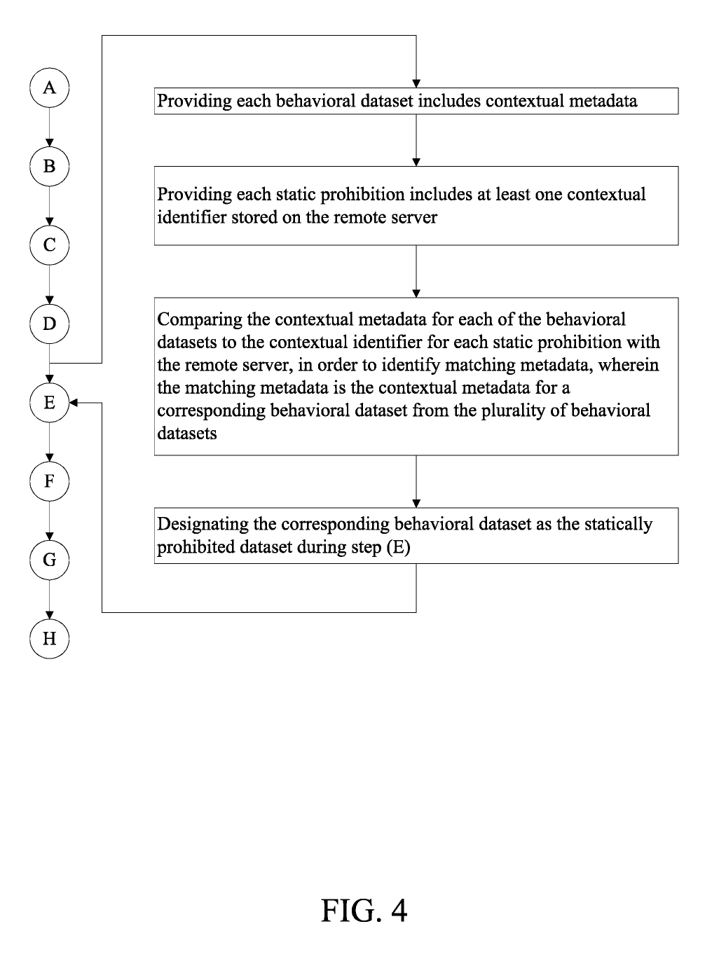

Referring to FIG. 4, the method of the present invention employs a sub-process for identifying statically prohibited behaviors, which is similar to the sub-process for identifying rewarded behaviors. To that end, the system required to execute the method of the present invention provides at least one contextual identifier for each static prohibition that is stored on the remote server. The contextual identifier describes the types of behavioral datasets which the method of the present invention will deem to fall under a corresponding static prohibition. The sub-process begins by comparing the contextual metadata for each of the behavioral datasets to the contextual identifier for each static prohibition with the remote server, in order to identify matching metadata. In this step, the matching metadata is the contextual metadata for a corresponding behavioral dataset from the plurality of behavioral datasets. Further, the comparison between the contextual identifier and the contextual metadata is used to identify the behavioral dataset that should be characterized as the statically prohibited dataset during Step E.

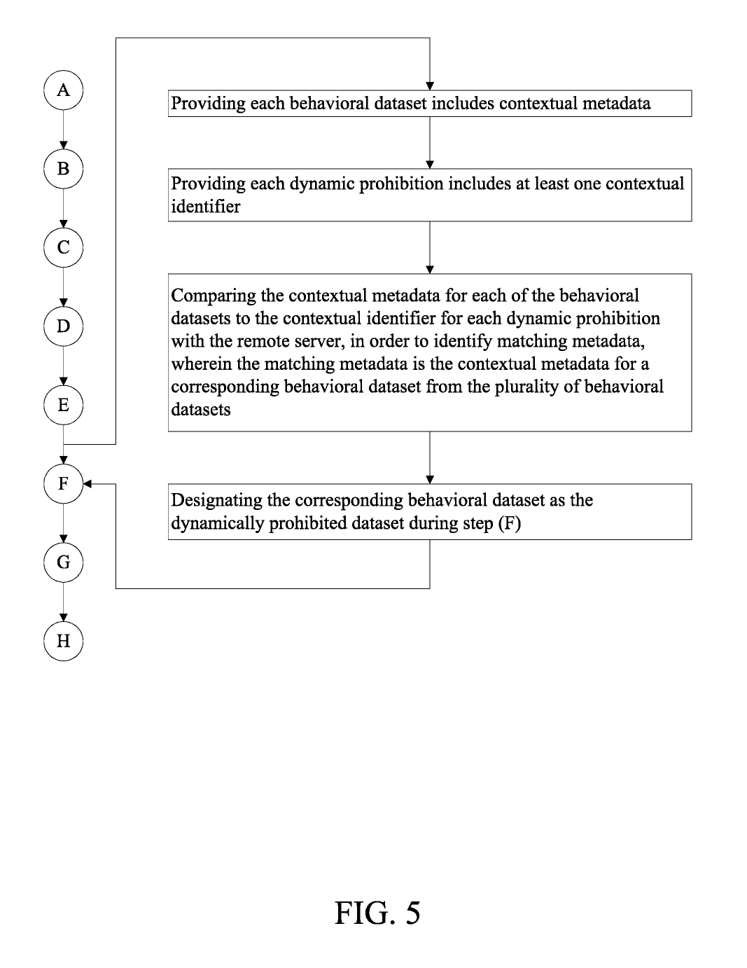

Referring to FIG. 5, the method of the present invention employs a sub-process for identifying dynamically prohibited behaviors, which is similar to the sub-process for identifying statically prohibited behaviors. To that end, the system required to execute the method of the present invention provides at least one contextual identifier for each dynamic prohibition that is stored on the remote server. The contextual identifier describes the types of behavioral datasets which the method of the present invention will deem to fall under a corresponding dynamic prohibition. The sub-process begins by comparing the contextual metadata for each of the behavioral datasets to the contextual identifier for each dynamic prohibition with the remote server, in order to identify matching metadata. In this step, the matching metadata is the contextual metadata for a corresponding behavioral dataset from the plurality of behavioral datasets. Further, the comparison between the contextual identifier and the contextual metadata is used to identify the behavioral dataset that should be characterized as the dynamically prohibited dataset during Step F.

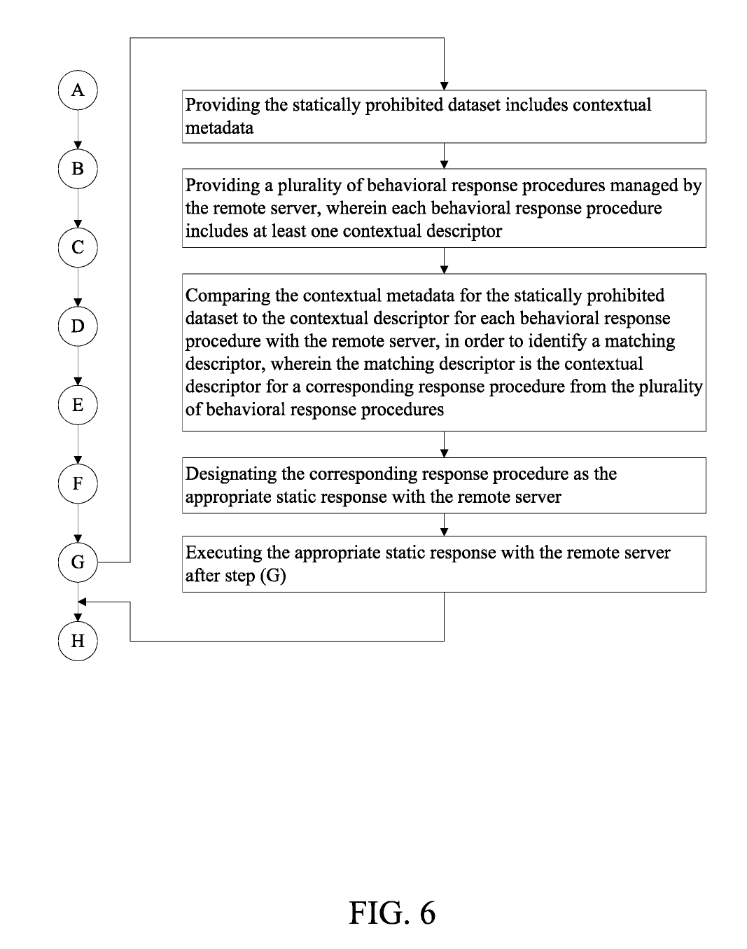

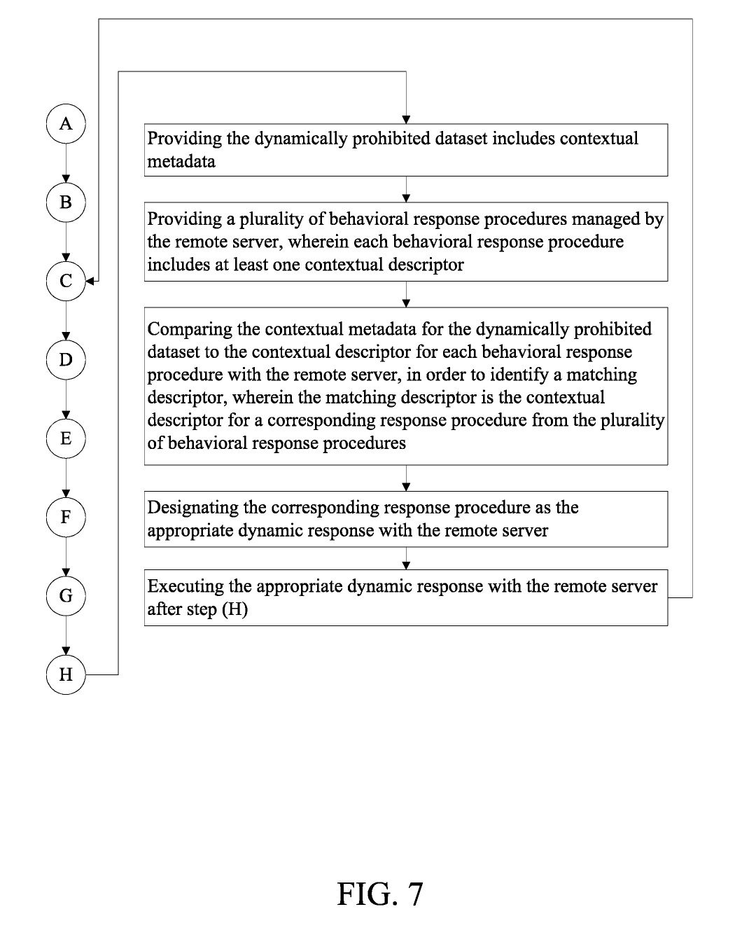

Referring to FIG. 6 and FIG. 7, the method of the present invention is designed to be situationally relevant, such that behaviors which would be prohibited in one context are allowed in the next. To that end, the method of the present invention employs the behavioral modification process to analyze the context surrounding each of the behavioral datasets in order to determine the actions that should be taken in response to the child engaging in a host of activities. To enable this functionality, the system required to execute the method of the present invention provides a plurality of behavioral response procedures managed by the remote server. Each of the behavioral response procedure is a preset routine that the method of the present invention will execute to prevent the child from engaging in prohibited activities, and to inculcate positive values within the child. Additionally, each of the behavioral response procedures includes at least one contextual descriptor. The contextual descriptor is a classification token that describes a specific contextual milieu for which a corresponding behavioral response procedure will be appropriate.

Referring to FIG. 6 and FIG. 7, as described above, the behavioral modification process is used to implement two sub-processes which generate the appropriate static response and the appropriate dynamic response to behavioral datasets which are characterized as prohibited in some way. A first sub-process, is used to generate the appropriate static response, and begins by comparing the contextual metadata for the statically prohibited dataset to the contextual descriptor for each behavioral response procedure with the remote server, in order to identify a matching descriptor. In this step, the matching descriptor is the contextual descriptor for a corresponding response procedure from the plurality of behavioral response procedures. Further, the comparison between the contextual descriptor and the contextual metadata is used by the remote server to identify the behavioral response procedure that should be characterized as the appropriate static response. The first sub-process concludes by executing the appropriate static response with the remote server after during Step G. A second sub-process, is used to generate the appropriate dynamic response, and begins by comparing the contextual metadata for the dynamically prohibited dataset to the contextual descriptor for each behavioral response procedure with the remote server, in order to identify a matching descriptor. In this step, the matching descriptor is the contextual descriptor for a corresponding response procedure from the plurality of behavioral response procedures. Further, the comparison between the contextual descriptor and the contextual metadata is used by the remote server to identify the behavioral response procedure that should be characterized as the appropriate dynamic response. The second sub-process concludes by executing the appropriate dynamic response with the remote server after during Step H.

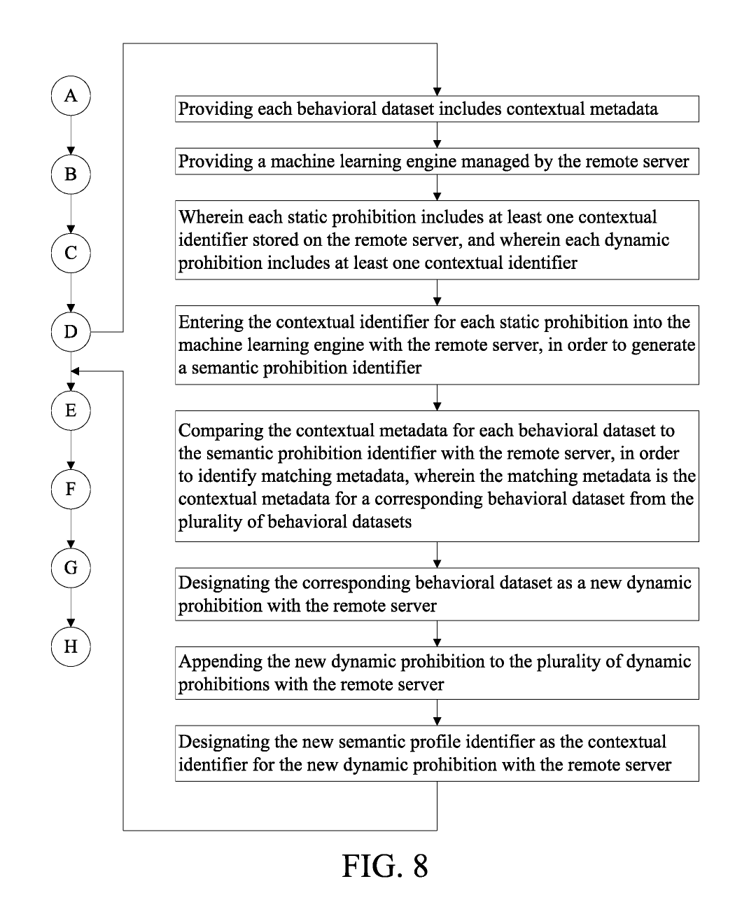

Referring to FIG. 8, the method of the present invention is designed to use machine learning techniques when generating the plurality of dynamic prohibitions. To that end, the method of the present invention includes a sub-process that employs the machine learning engine to construct a semantic model which describes the parent's overall approach to behavioral modification. Specifically, the machine learning engine, is managed by the remote server, and used to analyze both the child's behavioral datasets, as well as the static prohibitions associated to the child profile. This sub-process begins by entering the contextual identifier for each static prohibition into the machine learning engine with the remote server, in order to generate a semantic prohibition identifier. The semantic prohibition identifier is a fuzzy-logic-based classification token that compiles the contextual identifiers into a model which describes a prohibited behavior. That is, the semantic prohibition identifier is a prediction model that is generated by the machine learning engine. Further, the machine learning engine uses the plurality of static prohibitions as training data when generating the semantic prohibition identifier. Relatedly, the machine learning engine may include dynamic prohibitions that were previously identified in the training data. As a result, the method of the present invention is able to function as an unsupervised parental controls system that remains relevant regardless of changes in the child's behaviors. The sub-process continues by comparing the contextual metadata for each behavioral dataset to the semantic prohibition identifier with the remote server, in order to identify matching metadata. In this step, the matching metadata is the contextual metadata for a corresponding behavioral dataset from the plurality of behavioral datasets. Further, the comparison between the semantic prohibition identifier and the contextual metadata is used by the remote server to identify the corresponding behavioral dataset as a behavioral dataset that is indicative of a behavior which should be prohibited. Thus, the sub-process continues by designating the corresponding behavioral dataset as a new dynamic prohibition with the remote server. The sub-process continues by appending the new dynamic prohibition to the plurality of dynamic prohibitions with the remote server. The sub-process concludes by designating the new semantic profile identifier as the contextual identifier for the new dynamic prohibition with the remote server. Accordingly, the method of the present invention will be able to respond appropriately if the child engages in the newly identified activity.

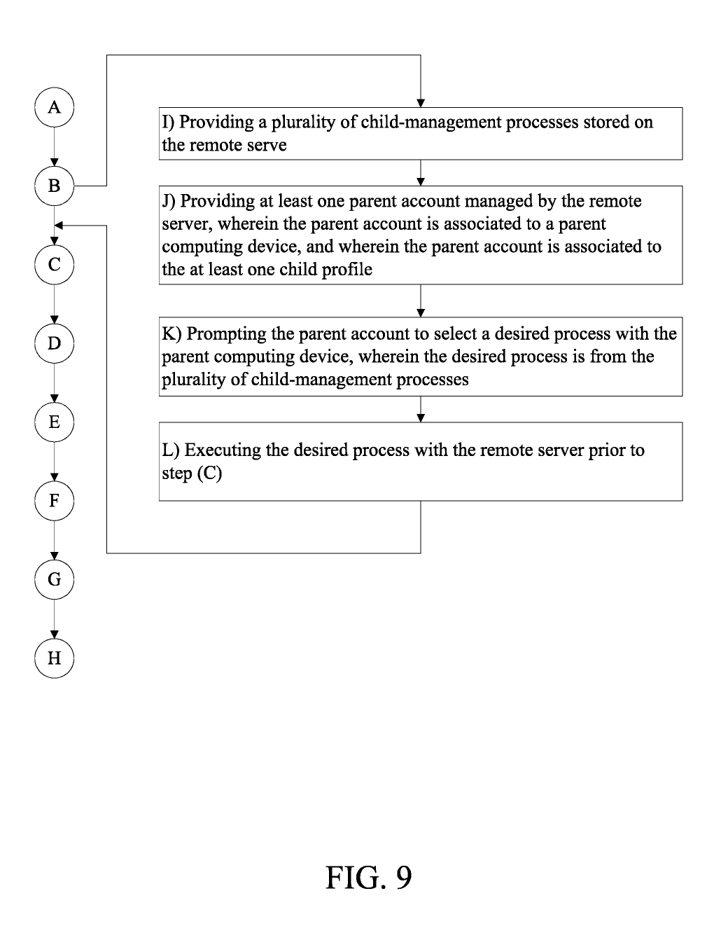

Referring to FIG. 9, the method of the present invention is designed to enable the parent to manage every aspect of the child's interactions with the child computing device. To accomplish this, the system required to execute the method of the present invention provides a plurality of child-management processes stored on the remote server (Step I). Each of the child-management processes is a routine that enables the parent to control a specific aspect of the child profile. For example, the plurality of child-management processes may comprise processes that include, but are not limited to, creating new static prohibitions, creating new child profiles, monitoring the child's activities in real time, and creating behavioral response procedures. The system required to execute the method of the present invention further provides at least one parent account managed by the remote server (Step J). The parent account is a unique record that contains the parent's saved preferences and enables the parent to manage the child profile. Additionally, the parent account is associated to a parent computing device. Further, the parent account is associated to the at least one child profile. Consequently, the parent is able to monitor the activities of one or more child. The parent's interactions with the method of the present invention are mediated through a sub-routine that presents the parent with an interactive interface which receives the parent's commands and outputs system information. This sub-routine begins by prompting the parent account to select a desired process with the parent computing device (Step K). The desired process is from the plurality of child-management processes. Accordingly, the parent is provided with a graphical user interface (GUI) that enables the parent to interact with the present invention by inputting commands. The sub-routine continues by executing the desired process with the remote server prior to Step C (Step L). Consequently, the sub-routine initiates sub-processes that correspond to the desired process.

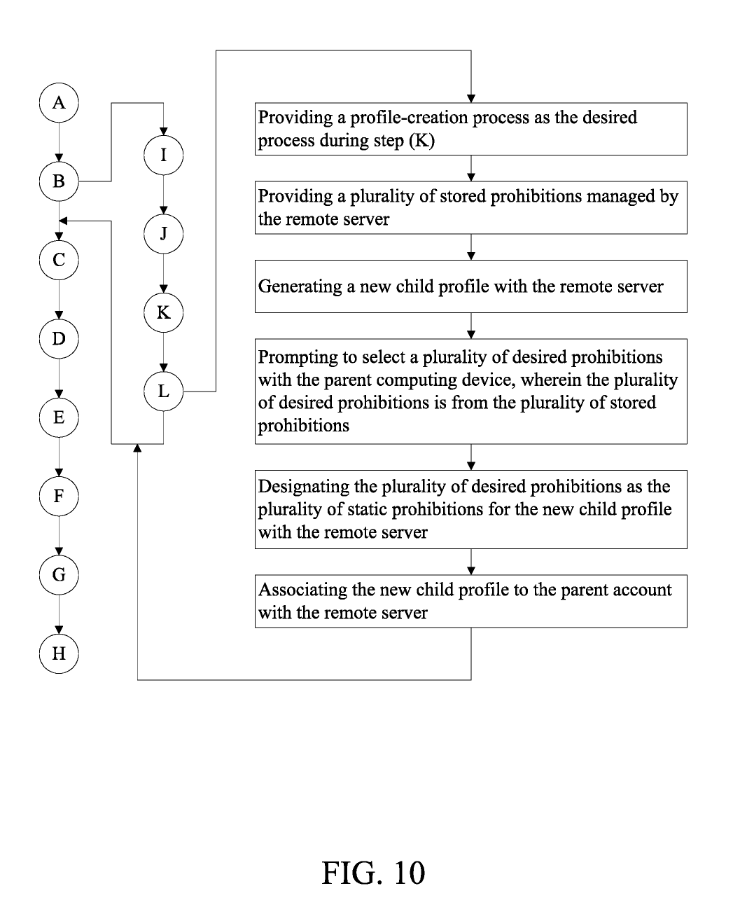

Referring to FIG. 10, the method of the present invention is designed to enable the parent to create a child profile for one or more children whose activities must be monitored. The parent is able to employ this functionality by selecting a profile-creation process as the desired process during Step K. Further, this functionality is enabled because the system required to execute the method of the present invention provides a plurality of stored prohibitions that are managed by the remote server. Each of the stored prohibitions is a static prohibition that was previously supplied to the remote server. After the parent selects the profile-creation process as the desired process, the remote server initiates a sub-process that begins by generating a new child profile with the remote server. The new child profile functions as a record of the child whose activities will be monitored by the parent. The sub-process continues by prompting to select a plurality of desired prohibitions with the parent computing device. The parent is then directed to select the desired prohibitions, from the plurality of stored prohibitions, that will be used to modify the child's behavior. The sub-process continues by designating the plurality of desired prohibitions as the plurality of static prohibitions for the new child profile with the remote server. Thus, the new child profile is supplied with a list of static prohibitions that will be used to modify the child's behavior in conjunction with the plurality of dynamic prohibitions. The sub-process concludes by associating the new child profile to the parent account with the remote server. Once the new child profile is created, the parent is able to monitor and modify the child's activities while using the child computing device.

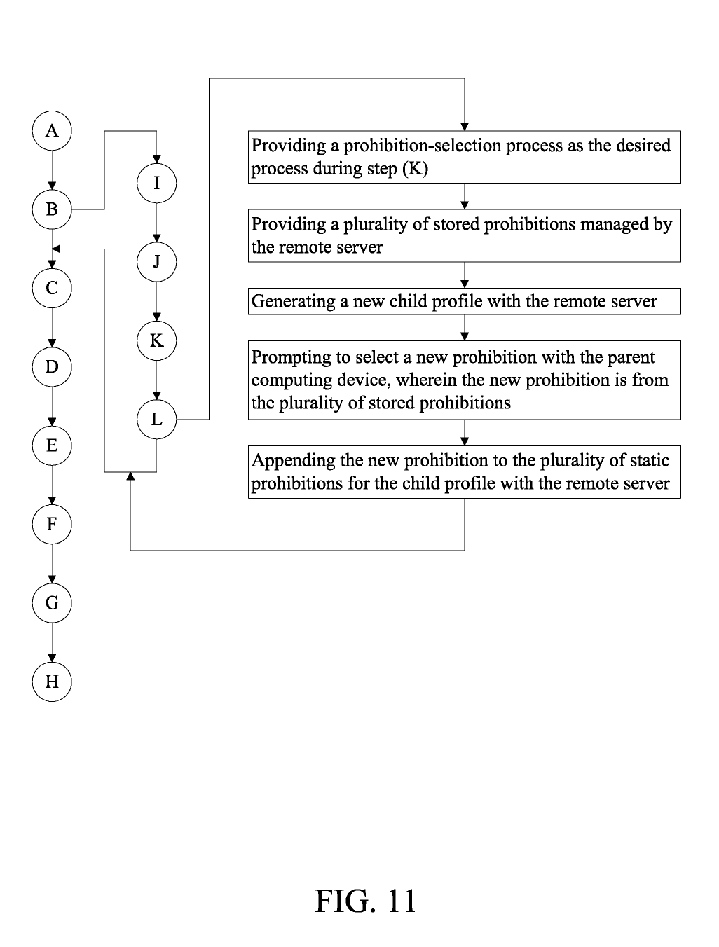

Referring to FIG. 11, the method of the present invention is designed to enable the parent to add new static prohibitions to the child profile. The parent is able to employ this functionality by selecting a prohibition-selection process as the desired process during Step K. After the parent selects the prohibition-selection process as the desired process, the remote server initiates a sub-process that begins by prompting to select a new prohibition with the parent computing device. The parent is then directed to select the new prohibitions, from the plurality of stored prohibitions, that will be used to modify the child's behavior. The sub-process concludes by appending the new prohibition to the plurality of static prohibitions for the child profile with the remote server. Thus, the new child profile is supplied with a new static prohibition that will be used to modify the child's behavior in conjunction with the plurality of dynamic prohibitions.

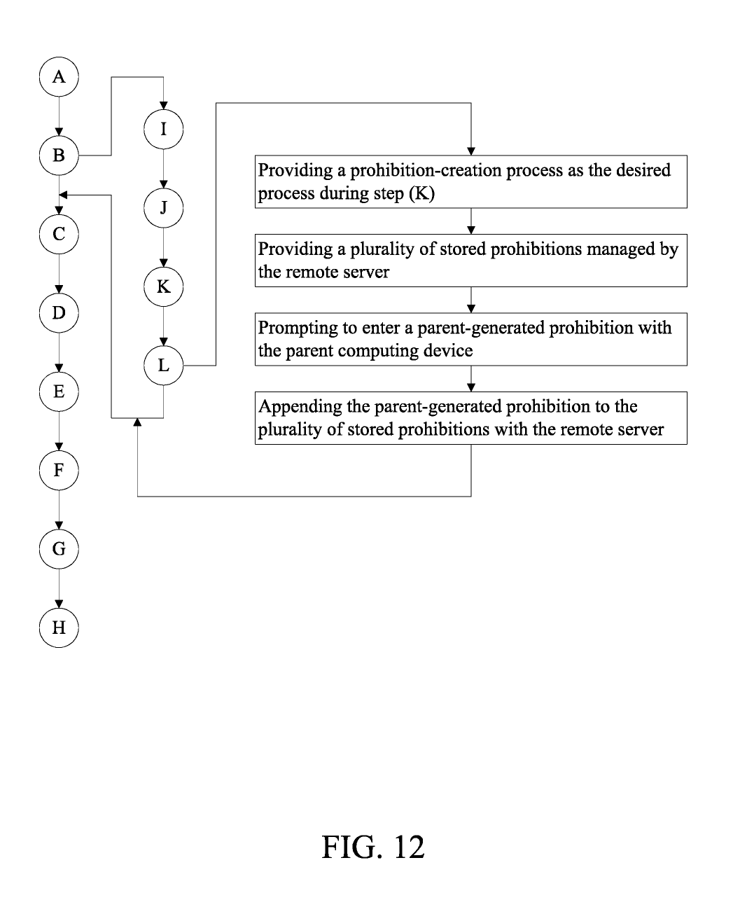

Referring to FIG. 12, the method of the present invention is designed to enable the parent to create new stored prohibitions. The parent is able to employ this functionality by selecting a prohibition-creation process as the desired process during Step K. After the parent selects the prohibition-creation process as the desired process, the remote server initiates a sub-process that begins by prompting to enter a parent-generated prohibition with the parent computing device. This step enables the parent to fully characterize a stored prohibition that can be appended to the child profile and then used to modify the child's behavior. The sub-process concludes by appending the parent-generated prohibition to the plurality of stored prohibitions with the remote server. Thus, the parent-generated prohibition is stored in the remote server and can be called upon as the parent deems necessary.

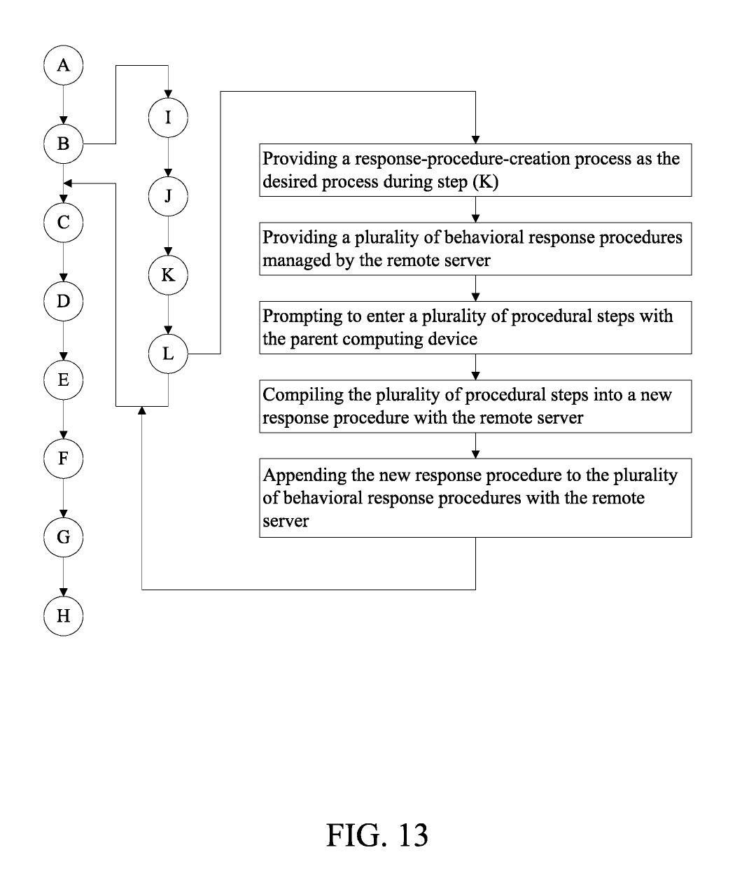

Referring to FIG. 13, the method of the present invention is designed to enable the parent to create new behavioral response procedures. The parent is able to employ this functionality by selecting a response-procedure-creation process as the desired process during Step K. The response-procedure-creation process enables the parent to define the specific steps that should be taken when a behavioral dataset is characterized as statically prohibited, dynamically prohibited, or rewarded. After the parent selects the response-procedure-creation process as the desired process, the remote server initiates a sub-process that begins by prompting to enter a plurality of procedural steps with the parent computing device. This step enables the parent to supply the steps that will be taken in the behavioral response procedure that is being created. The sub-process continues by compiling the plurality of procedural steps into a new response procedure with the remote server. Each of the procedural steps is sequentially arranged to generate a single routine that will be executed as a behavioral response procedure. The sub-process concludes by appending the new response procedure to the plurality of behavioral response procedures with the remote server. Thus, the response procedure is stored in the remote server and can be executed as required.

Although the invention has been explained in relation to its preferred embodiment, it is to be understood that many other possible modifications and variations can be made without departing from the spirit and scope of the invention as hereinafter claimed.

1. A method for implementing intelligent parental controls comprising steps of:
providing a child profile, a parent account, a machine learning engine, a child computing device, a parent computing device, a remote server, a behavioral modification process, a plurality of stored prohibitions and a plurality of child-management processes, managing the child profile, the parent account, the machine learning engine, the behavioral modification and the plurality of stored prohibitions process by the remote server, storing the plurality of child-management processes on the remote server, associating the child profile with the child computing device, associating the parent account with the parent computing device and associating the parent account with the child profile, wherein the child profile comprises a plurality of static prohibitions and a plurality of dynamic prohibitions, and each of the plurality of static prohibitions and each of the plurality of dynamic prohibitions comprises a contextual identifier stored on the remote server;
prompting the parent account to select a desired process by the parent computing device, wherein the desired process is from the plurality of child-management processes;
providing a prohibition-selection process as the desired process;
executing the desired process by the remote server;
prompting the parent account to select a new static prohibition by the parent computing device, wherein the new static prohibition is from the plurality of stored prohibitions;
appending the new static prohibition to the plurality of static prohibitions for the child profile by the remote server;
continually monitoring the child computing device by the remote server in order to identify a behavioral trigger;
receiving a plurality of behavioral datasets from the child computing device, if the behavioral trigger is identified, wherein the plurality of behavioral datasets are associated to the child profile, and each of the plurality of behavioral datasets comprises contextual metadata;
entering the contextual identifier for each static prohibition into the machine learning engine by the remote server, in order to generate a semantic prohibition identifier, the semantic prohibition identifier being a fuzzy-logic-based classification token;
comparing the contextual metadata for each behavioral dataset to the semantic prohibition identifier by the remote server, in order to identify matching metadata, wherein the matching metadata is the contextual metadata for a corresponding behavioral dataset from the plurality of behavioral datasets;
designating the corresponding behavioral dataset as a new dynamic prohibition by remote server;
appending the new dynamic prohibition to the plurality of dynamic prohibitions by the remote server;
contextually comparing each of the plurality of behavioral datasets to the plurality of static prohibitions by the remote server, in order to identify a statically prohibited dataset, wherein the statically prohibited dataset is from the plurality of behavioral datasets;
contextually comparing each of the plurality of behavioral datasets to the plurality of dynamic prohibitions by the remote server, in order to identify a dynamically prohibited dataset, wherein the dynamically prohibited dataset is from the plurality of behavioral dataset;
generating an appropriate static response by the remote server by inputting the statically prohibited dataset into the behavioral-modification process, if the statically prohibited dataset is identified; and
generating an appropriate dynamic response by the remote server by inputting the dynamically prohibited dataset into the behavioral-modification process, if the dynamically prohibited dataset is identified.

2. (canceled)

3. The method for implementing intelligent parental controls as claimed in claim 1 comprising steps of:
further designating the corresponding behavioral dataset as the statically prohibited dataset.

4. The method for implementing intelligent parental controls as claimed in claim 1 comprising steps of:
further designating the corresponding behavioral dataset as the dynamically prohibited dataset during.

5. The method for implementing intelligent parental controls as claimed in claim 1 comprising steps of:
providing a plurality of behavioral response procedures managed by the remote server, wherein each behavioral response procedure comprises a contextual descriptor;
comparing the contextual metadata for the statically prohibited dataset to the contextual descriptor for each behavioral response procedure by the remote server, in order to identify a matching descriptor, wherein the matching descriptor is the contextual descriptor for a corresponding response procedure from the plurality of behavioral response procedures;
designating the corresponding response procedure as the appropriate static response by the remote server; and
executing the appropriate static response by the remote server.

6. The method for implementing intelligent parental controls as claimed in claim 1 comprising steps of:
providing a plurality of behavioral response procedures managed by the remote server, wherein each behavioral response procedure comprises a contextual descriptor;
comparing the contextual metadata for the dynamically prohibited dataset to the contextual descriptor for each behavioral response procedure by the remote server, in order to identify a matching descriptor, wherein the matching descriptor is the contextual descriptor for a corresponding response procedure from the plurality of behavioral response procedures;
designating the corresponding response procedure as the appropriate dynamic response by the remote server; and
executing the appropriate dynamic response by the remote server.

7. (canceled)

8. (canceled)

9. The method for implementing intelligent parental controls as claimed in claim 1 comprising steps of:
further providing a profile-creation process as the desired process;
generating a new child profile by the remote server;
prompting the parent account to select a plurality of desired prohibitions by the parent computing device, wherein the plurality of desired prohibitions are from the plurality of stored prohibitions;
designating the plurality of desired prohibitions as the plurality of static prohibitions for the new child profile by the remote server; and
associating the new child profile with the parent account by the remote server.

10. (canceled)

11. The method for implementing intelligent parental controls as claimed in claim 1 comprising steps of:
further providing a prohibition-creation process as the desired process;
prompting the parent account to enter a parent-generated prohibition by the parent computing device; and
appending the parent-generated prohibition to the plurality of stored prohibitions by the remote server.

12. The method for implementing intelligent parental controls as claimed in claim 1 comprising steps of:
further providing a response-procedure-creation process as the desired process;
providing a plurality of behavioral response procedures managed by the remote server;
prompting the parent account to enter a plurality of procedural steps by the parent computing device;
compiling the plurality of procedural steps into a new response procedure by the remote server; and
appending the new response procedure to the plurality of behavioral response procedures by the remote server.

13. The method for implementing intelligent parental controls as claimed in claim 1 comprising steps of:
providing a plurality of behavioral response procedures managed by the remote server, wherein each behavioral response procedure comprises a contextual descriptor;
providing a plurality of rewarded behaviors included in the child profile, wherein each rewarded behavior comprises a contextual identifier stored on the remote server;
comparing the contextual metadata for each of the behavioral datasets to the contextual identifier for each rewarded behavior by the remote server, in order to identify matching metadata, wherein the matching metadata is the contextual metadata for a corresponding rewarded behavioral dataset from the plurality of behavioral datasets;
comparing the contextual metadata for the rewarded behavioral dataset to the contextual descriptor for each behavioral response procedure by the remote server, in order to identify a matching descriptor, wherein the matching descriptor is the contextual descriptor for a corresponding response procedure from the plurality of behavioral response procedures; and
executing the corresponding response procedure by the remote server.
